(19) United States
(12) Patent Application Publication
(10) Pub. No.: US 2005/0252790 A1
(43) Pub. Date: Nov. 17, 2005

(54) Electrochemical sensor system and sensing method

(76) Inventors: John Vincent Dobson, Durham (GB); Robert Neil Marshall, Durham (GB)

Correspondence Address: SUGHRUE MION, PLLC, 2100 PENNSYLVANIA AVENUE, N.W., SUITE 800, WASHINGTON, DC, 20037, US

(21) Appl. No.: 10/510,688

(22) PCT Filed: Mar. 28, 2003
(86) PCT No.: PCT/GB03/01383

§ 371 Date: Jun. 7, 2005

(30) Foreign Application Priority Data
Apr. 9, 2002 (GB) 0208095.0

(51) Int. Cl. G01N 27/26

(52) U.S. Cl. 205/789; 204/412; 204/416

(57) ABSTRACT

The invention relates to a sensor system for the identification and/or measurement of levels of target species in aqueous solution, and in particular for the identification and/or determination of levels of contaminant species such as nutrient species in the aqueous phase.

The invention relates to a sensor system for the identification and/or measurement of levels of target species in aqueous solution, and in particular for the identification and/or determination of levels of contaminant species such as nutrient species in the aqueous phase.

The invention is particularly directed to the provision of such a sensor system in portable/hand-held and convenient form and/or adapted for use for the identification and/or measurement of levels of target species in water in a real (i.e. non-laboratory) and in particular external environment. The invention also relates to a method for the identification and/or determination of levels of target species in aqueous solution.

Sensors already exist for the determination of the presence of contaminant species in water, in particular nutrient and related species such as ammonia, ammonium, nitrates, nitrites and other ions, which are found in natural and industrial water.

The measurement of these species at the low concentrations that may be present in aqueous fluids is very important in a number of areas, including
a) High purity boiler feed water supplies for power stations.
b) Drinking water production and maintenance of purity of supplies, including untreated and treated river waters for water extraction.
c) Waste water and sewage treatment processes.
d) Steel work effluents and other trade water wastes.
e) The agricultural industry has strong requirements to measure levels of ammonia/ammonium ion and like contaminants. Here salt rich fertilisers and their resultant leaching into water bodies are a concern.
f) Furthermore even animal slurries and routes of disposal are sources where ammonia/ammonium ion and like contaminants are present.
g) In the food industry analysis of beer, wine, milk and meat products is carried out for ammonia/ammonium ion concentration levels.
h) Clinical analysis in the medical world relies upon ammonia/ammonium ion measurements when considering liver and kidney efficiencies in particular urea and urine relationships. Even levels as low as 5 mg ammonia per 100 ml of blood are toxic to humans.

Existing basic devices often employ potentiometric principles where a potential only is measured. The output from the ion selective electrode (ISE) is indirectly related to the log of the concentration of the species of interest, in the water sample. A common example of an ISE is a glass pH electrode. These glass and other types of ion exchange membrane electrodes are readily available from a number of suppliers at costs often several hundred pounds. However, ISEs in general have well known problems and limitations, such as poisoning and restrictions of use in certain environments.

Ion exchange membrane plastic type electrodes suffer badly from the effects of debris in the aqueous sample, surfactants, particulate material, etc., can cause deterioration of the sensors performance. ISE electrodes whatever the type and nature of the membrane must therefore be routinely cleaned, ideally after each measurement.

Calibration of all ISEs is also a time consuming and costly procedure. The procedure requires at the very least a minimum of laboratory training so that the electrode and measured value obtained can be relied upon. Hence care and a fair degree of scientific skill are necessary to ensure satisfactory operation.

A most important limitation of the present sensor technology is the inability of such sensors to be used directly in waters which have high levels of salinity. Corrections and further preparations for the measurement technique are required. Their instant use is therefore excluded from waters in this category which may be estuarine, or coastal, without substantial preparation of the sample. These factors are a significant drawback to their general use.

Other well known methods for analysis of ammonia/ammonium ion and other water contaminant species also exist using various ‘wet’ chemical techniques often relying upon a colour change or similar. These methods require even more of a degree of technical skill and experience to be used successfully than the ISE electrode technology discussed above. Additionally these wet methods are prone to interference from the strong oxidising or reducing agents or complexing species found in the water samples. Well known wet methods require a sample to be taken to the laboratory for measurement with suitable bench type equipment, e.g., ion chromatography, Kjeldahl apparatus, etc. However, these types of measurements are often accepted as standard, but require time, effort, and technical data interpretation problems by qualified staff.

Thus to overcome these particular problems considerable time and effort is required for sample preparation and pre-treatment.

It is also generally the case that the ability of existing analysis measurement systems for ammonia/ammonium ion and other target species to give data immediately or in-situ with ease and reliability in seawater and brackish waters is limited.

It is an object of the invention to provide an in-situ use sensor system and method that also mitigates some or all of the above disadvantages in relation to the monitoring of the concentration, or presence, or presence at a predetermined level of a target water contaminant and in particular a nutrient species such as ammonia/ammonium ion, nitrate, nitrite, etc.

It is a particular object of the invention to provide a sensor system and method that employs established electrochemical principles in a manner that is reliable, cost effective and user friendly.

It is a particular object of the invention to provide a sensor system and method that lends itself to use in in-situ site use in the field and/or by relatively untrained personal.

Thus, according to the invention in a first aspect, a sensor system for measuring the concentration, or indicating the presence or presence at a predetermined level of, a target contaminant species in an aqueous medium comprises a sensor element having a sample receiving area for receiving a sample of aqueous medium to be sampled and which comprises at least three electrodes each comprising a layer of conductor deposited upon an insulating substrate, and further comprising a power source adapted to apply a pre-determined potential difference across two of the electrodes determined by the potential associated with an electrochemical reaction characteristic of the target species, and output means to output data corresponding to the current generated thereby when a sample is in place on the sampling area.

The active part of the sensor system thus comprises three active small mutually insulated electrode sites in the sample collection area and contacting the aqueous sample in use. The general principles of chemistry underlying the operation of the sensor system in this active area will be known. The power source is connected to the sensor system to create a sensor system control circuit which can effectively function as a potentiostat.

Sensor system sensitivity performance can be improved by use of other well-known circuits producing cyclic voltammetry measurements or better differential square wave pulsed techniques. The latter could easily replace the constant potential amperometry described in this patent.

Two electrodes are polarised in the sample collection area at a pre-determined particular potential characteristic of an electrochemical reaction (E^{O}) indicative of the species under investigation. Polarising the electrodes results in generation of a current as the electrochemical reaction involving the target species proceeds, and this quite rapidly settles into a steady change state where the current is proportional to the concentration of the target species. One of the electrodes is used to provide a reference point so that the working electrode can be set at a specific potential. The third electrode, the counter, completes the circuit.

The applied voltage, which is carefully selected to carry out the specific and unique process or reaction in the sensor cell, results ultimately in the generation of an electric current. This current is directly related to the process being carried out at the sensor cell and is either an oxidation or reduction process at the working electrode.

Although the system employs known and established electrochemical principles, the sensor is greatly simplified over many prior art systems, which employ large-scale electrodes and/or which employ potentiometric principles where a potential difference is measured. In particular it will be seen, the sensor is in effect pre-calibrated and provided with an integral reference electrode. There is no need for calibration in the field. The first sample of liquid on the sample receiving surface produces a potential change. This goes to a pseudo steady state in a relatively short time.

The system requires only a small sample of liquid to function effectively. For example a single drop or a few such drops of liquid to be tested may be applied to the sample receiving area. Larger quantities of sample may be used. For example the sensor may be partly or completely immersed into a liquid to be tested such that a sample contacts the sample receiving area, either by direct immersion in situ or, more conveniently, by immersion of the sensor in a quantity of collected sample in a suitable container.

The electrodes acting in this manner are small, cheap and in a preferred embodiment are intended to be disposable. Because of the accurate control of properties of the electrodes which is possible by using conductor layer on insulating substrate technology, for example thick or thin film conductor technology, in particular with noble metals of very high purity, separate sensor electrode elements do not need to be separately calibrated. Purity of the metal deposited is crucial and highly important in obtaining acceptable repeatability. For a given material and electrode configuration combination the behaviour of the electrodes varies to a sufficiently small extent, when using very pure metal, to render this unnecessary. Consequently the sensor system is self referencing, and is therefore very easy to use in real environmental situations in the field to a reasonable level of accuracy.

A strong advantage of the present invention is in its ability to be used quickly for in-situ/in-field type measurements. In this respect an advantage by comparison with other methods that require collection of a sample and taking it back to a laboratory for analysis. Alternatively, and at best, pre-treating the sample on site and obtaining indifferent data from the method employed in its measurement.

In operation, a few millilitres, of solution is taken from the bulk sample, which might be a river, an ocean or simply a glass of water. This is placed for testing on the sample collection area.

To this sample may be added a pH buffering agent. This buffering agent is a preferably non-toxic chemical reagent, which will adjust the pH of the sample to a value acceptable and necessary for the characteristic electrochemical process to be tested. For example a buffering agent is selected to vary the pH of the initial solution to free into solution a species related to and indicative of the contaminant species under test, the characteristic electrochemical process to be tested by the sensor being one involving this related species.

In an example, when testing for ammonia/ammonium ion, a solution of interest would have a buffer added, changing the pH of the test solution to about pH 11 to 12. At this alkaline pH value, and with the application of a suitable and specific voltage, free liberated ammonia present in the sample is oxidised, by the current producing electrochemical process

Additionally or alternatively to this sample may be added a standard reference reagent, that is a reagent which sets up a suitable standard reference cell in situ involving the reference electrode to provide a reference for the working electrode. For example, suitable for target species such as ammonia/ammonium ion, then sodium chloride is added to a suitable standard solution concentration, for example at a concentration of around 30 gl⁻¹, to the solution. That is part of the standard solution described which, in conjunction with the silver reference electrode, will set up a standard Ag/AgCl reference in situ on the device.

In the measurement process only a small volume of sample is required, hence only a small quantity of buffering reagent is required to adjust the sample pH to a desired level irrespective of the original pH of the sample solution source. Equally, only a small quantity of standard reference reagent is required to adjust concentration levels in the sample to reference levels and this is again largely irrespective of the original level in the sample solution source. Both of these might vary between, for example, seawater, drinking water, and treated sewage effluents. Hence the process is straightforward and achievable with little cost, and effective regardless of the sample solution source.

A number of advantages will be apparent over prior art systems.

First, the electrode units are inexpensive to manufacture, allowing a measurement to be made by the user at little cost. It is practical for the electrodes to be intended for disposable single use. The sensor is not manufactured from glass and is therefore less fragile.

Second, the sensor system is simple to use. In a preferred embodiment it can be fabricated as a “black box” comprising, in compact operative association, a holder for a removable and optionally disposable electrode, a power source, an output means, access to the sample collection area when an electrode is inserted, and an actuator to initiate measurement, and optionally further a readily user readable display. Thus a user merely needs to insert an electrode, add of a drop of water, and press a button to initiate the measurement process. Hence there is no need or requirement for a highly trained or skilled operator.

Third, the measurement process is quick, requiring only one or two minutes or so before a subsequent measurement result is displayed. The measurement method is both safe and environmentally friendly, an important advantage over some existing methods. In practice the conditioning reagents do not require separate preparation (c.f. ISE system for example where a calibration is necessary then followed by reagent treatment of sample for measurement, etc,). With the sensor system all the necessary steps are obtained when the sample is put in contact with the electrode assembly.

An added and significant advance over the current methods of analysis generally available is that the sensor is largely unaffected by chemical materials commonly found in the aqueous environment. Debris will not influence the measurement process. Other ionic species present in the sample have been shown not to affect the sensor's performance. Deterioration of the sensor with time and routine use will not be a concern because of the intended protocol of operation. There is an ability to make measurements in aqueous samples that possess high levels of salinity. This will potentially allow measurements in estuarine waters, where salinity changes, or even in the sea and oceans where high levels of salinity are found. This is an important area where conventional ISE electrodes fail, or require special consideration of preparation. There are also areas in the medical world where an ammonia/ammonium ion sensor capable of use in a saline solution would be advantageous, e.g., blood, and urine analysis.

The power source causes the sensor system circuit to function as a potentiostat. To gain great sensitivity and repeatability, a variant of the simple potentiostatic circuit, that of a differential pulsed square wave voltammetric circuit could be used, and suitable control means are provided in the power source to effect this.

The power source may be any suitable electrical power source, and is preferably portable for use in the field, and for example comprises a battery, for example remotely rechargeable, a fuel cell, optionally disposable, or the like.

The output means deals with a primary output of a quasi steady state current, and comprises processing means to output this as unit readable data corresponding to this current in any suitable form. For example unit readable data may be suitable for output to any suitable display means and/or any suitable data register in data storage and/or processing means such as a computer. The output means might be adapted such that the data may correspond to measured current, which can then by compared to a reference database to produce useful data indicative of the concentration and/or presence and/or presence at a predetermined level of the target species in the solution under test.

Additionally or alternatively the output means may be associated with conversion circuitry to convert the primary output, for example by comparison to pre-recorded reference data, to secondary output comprising unit readable data directly indicative of indicative of the concentration and/or presence and/or presence at a predetermined level of the target species in the solution under test.

The sensor system preferably further comprises display means to display the output data in a user readable form. For example, the display may comprise an alphanumeric display indicative of the current generated in the circuit at steady state under test and/or indicative of the concentration and/or presence of the target species in the sample. Additionally or alternatively the display may comprise a digitised display adapted to indicate one of a small number of discrete states, for example presence or absence of the target species, or presence at a small number of pre-determined levels. Additionally or alternatively, the display may incorporate audio elements, for example emitting a sound if the target species is present or presence at a pre-determined level.

The sensor electrode unit is formed as three or more conductor electrodes provided as layers of conductive material, for example thick or thin films, on an insulating substrate, and so configured that a sample placed in the sample collection area wets the three electrodes simultaneously. Each of the at least three electrodes therefore presents a free external surface comprising at least a part of the sample collection area.

Preferably, the insulating support substrate has hydrophobic surface properties to assist in the retention of a static sample, and for example a single static drop of sample, in the sample collection area during sampling.

For convenience and compactness it will generally be preferable that the at least three electrodes are deposited on a single supporting substrate.

In a preferred embodiment, at least some of the at least three electrodes are provided concentrically in the sample collection area. For example, in an embodiment where three electrodes are provided the electrodes comprise a first electrode making up a central generally circular portion, and second and third electrodes concentrically annular or partially annular there around. For example, the central electrodes can serve as the working electrodes, the first outer annular electrode can serve as the reference electrode, and the second outer annular electrode can serve as the counter electrode. Clearly other geometric designs are possible for the layout of the electrode assembly.

In an embodiment where four electrodes are provided, the electrodes may again be similarly concentrically arrayed. In an alternative embodiment, one or other of the outer annular electrode areas is divided into two mutually insulating portions, to comprise two of the four electrodes. Other geometries will readily suggest themselves. Close control over the dimensions of the electrode components is essential.

Each electrode comprises a layer of conducting material and in particular metallic material laid down upon an insulating substrate. Suitable layer thicknesses are preferably below 1 mm. The layer is preferably applied as a film by any suitable film technology to form a conductive film on the substrate surface. Metallic layers can be fabricated by any suitable method, such as for example screen-printing, sputtering, evaporation, and associated techniques which are known for laying down and bonding metals to hydrophobic substrates. Manufacturing techniques suitable for producing either thin film or thick film electrode units are suitable for the functioning of the sensor system.

Preferably, the electrodes are fabricated from noble metals of high purity, and in particular of materials selected from silver, gold, platinum, palladium in substantially pure form or as alloyed combinations thereof, in particular with additional impurity levels of less than 0.5%, more preferably less than 0.05% and more preferably still less than 0.01%.

Electrodes fabricated from the materials and in the manner of the invention allow for carefully controlled electrode properties. As a consequence the system is in effect pre-calibrated, and it is not necessary to calibrate for each electrode. It is not necessary to calibrate the system in a reference solution before use in like manner to prior art sensor systems, in part because the invention enables the use of standard solution materials combined on the electrode units. The sensor system of the invention this offers the potential to replace more laborious laboratory based and less sensitive in-field analytical methods. Electrode materials and configurations can be pre-selected to be tailored to the electrochemical reaction to be used as characteristic of the target species.

Preferably, the sensor includes temperature measuring means and/or means to input a measured temperature at the time of sampling, and the conversion circuitry, or suitable software algorithms, or combinations thereof, then incorporates means to make a temperature compensation to raw output data based upon this temperature measurement relative to standard conditions.

The means to make a temperature compensation may comprise an electronic temperature compensation circuit. This temperature compensation circuit is used to overcome effects of external changes upon the standard and reference electrode potentials, and the temperature/current relationships via the Arrhenius Relationship. The temperature compensation circuitry becomes highly important when the system is used in hot countries or when there are temperature fluctuations. Alternatively to the temperature compensation circuitry would be an ‘offset’ controlled by an algorithm in suitable system software and related to a simple temperature measurement.

Additionally or alternatively, the sensor includes conductivity measuring means to measure conductivity of the sample solution on the electrodes at the time of sampling, and the conversion circuitry incorporates means to make a conductivity compensation to raw output data based upon this measurement relative to standard conditions.

In practice there would be included provision to initiate a rapid and short measurement of electrical conductivity immediately after ‘Switch On’. This short and rapid conductivity measurement would conveniently be coupled with the offset circuitry/software described in relation to temperature correction and/or with offset circuitry/software analogous thereto. The stored values are compared or related to an independent knowledge of the value of conductivity of the standard solution. This provision would allow the equipment to be used without any external switch on the instrument when used for measurement of a wide variety of basic compositions (river-water, sea-water, etc).

The device thus always gives the same signal for the particular target species concentration being measured. Moreover, the occasional apparent curvature and minor variations noted of signal at low concentrations of target ion is amply corrected and eliminated.

The invention performs a simple test in a convenient and portable manner rapidly and without the need for detailed pre-calibration or for a separate reference electrode and is thus particularly suited to use in the field. The sensor is potentially more accurate than prior art systems for use in the field, and offers levels of accuracy to present an effective in field alternative to prior art use of sampling and subsequent examination by expensive laboratory equipment at a remote site.

Since the device measures changes in current, a direct and linear relationship exists to target species concentration, which further simplifies its use in determining such concentration. This contrasts with prior art potentiometric methods, where a logarithmic relationship exists between the potential change measured by the device and the concentration.

The electrode is self referencing. In accordance with the principle of operation of the sensor system, this is achieved by provision of an integral reference electrode, and by chemical modification of the sample in situ to create a reference solution. This can be achieved by adding the reference medium to the drop in situ. However in a preferred embodiment, the sensor element is provided with a layer of a suitable chemical species deposited on the upper surface in the sample collection area such as to be rapidly and very soluble in the aqueous sample and placed thereon to effect formation of a suitable reference solution for operation of the reference electrode. Where applicable, a suitable buffering species may be similarly applied additionally or alternatively.

For example, in many instances a silver/silver chloride reference system with a alkaline sodium chloride reference solution will be familiar. This is the case for instance in prior art systems for the measurements of ammonia/ammonium ion levels. In this instance, a sample is collected on the sample collection area and sodium chloride added to a standard level. This may be added separately once the sample is in place, but is conveniently provided in the form of a deposited layer of standard reagent to sufficient level to go into solution once the aqueous sample is placed on the sample collection area and thus effect formation of the referenced solution. Other deposited species will be appropriate for other reference standards.

A preferred method of manufacture of electrodes is to cover or paint the electrode area with standard mixture solution and allow to dry. The electrode is preferably then protectively packaged for environmental protection, for example protectively packed in plastic, say a thin polythene container for storage, before being used for measurements.

Alternatively, there is further provided a matting layer applicable to the electrode surface and pre-impregnated with standard mixture solution. The matting may be very fine woven or non-woven material, such as plastic material, which has the capability to absorb water. This is soaked with standard mixture solution and allowed to dry. In a preferred embodiment, matting of suitable size and shape to cover an electrode sample collection area is provided in kit form in combination with an electrode to be slipped over or temporarily affixed on to the electrode prior to use. This would provide a larger reservoir than a simple painted surface preparation. Both alternatives avoid the need to provide additional standard reagent and offer a simple single use electrode element.

In accordance with the invention in a further aspect there is provided a method of measuring the concentration, or indicating the presence or presence at a predetermined level of a target contaminant species in an aqueous medium comprising the steps of:
applying a sample of aqueous medium to be tested on a sample collection area of a sensor element comprising at least three electrodes each comprising a layer of conductor deposited upon an insulating substrate;
optionally causing a suitable chemical species to go into solution in the aqueous sample to create a suitable reference solution for the pre-determined electrochemical reaction;
connecting the electrode to a power source to set up a control circuit, for example a potentiostatic type or other suitable circuit, applying a pre-determined potential difference determined by the potential associated with an electrochemical reaction characteristic of the target species;
awaiting the establishment of a steady state or quasi steady state;
outputting data associated with the current of said steady state;
optionally converting the said output current data into data indicative of the presence or presence at a pre-determined level and/or level of concentration of the target species in the sample;
and/or optionally displaying the output data or converted data on suitable user readable display means;
and/or optionally transmitting the output data or converted data to suitable data storage and/or processing means.

In one alternative of the method a reference solution is created by addition of a suitable chemical species to the collected sample in situ in the sample collection area. In another alternative the sample collection area of the sensor element is pre-prepared by provision of the suitable chemical species deposited thereon in solid form and able to go into solution when the aqueous sample is applied thereto to effect formation of the reference solution.

Other preferred features of the method of the invention will be understood by analogy with the foregoing.

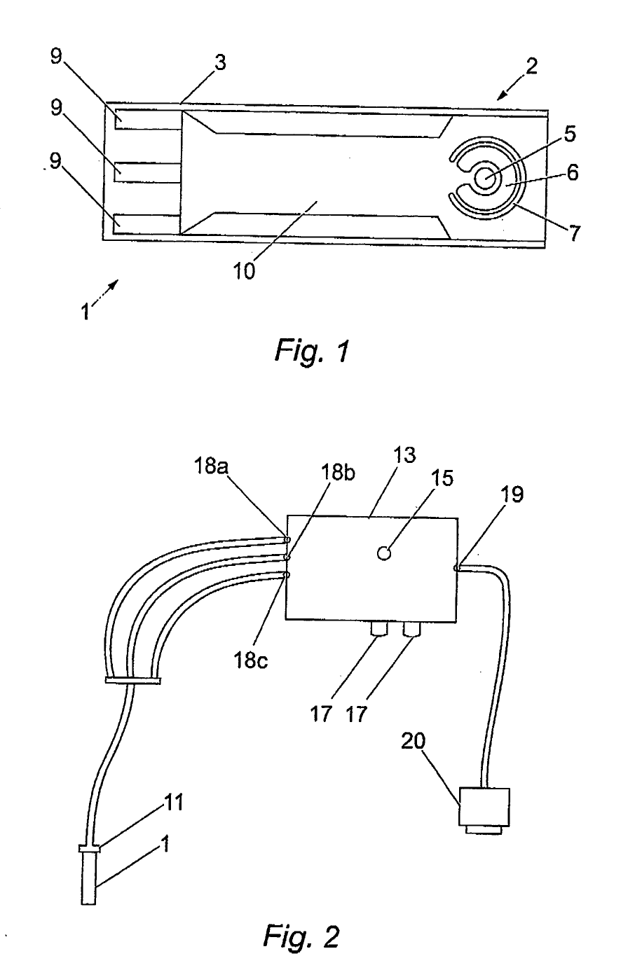

The invention will now be described by way of example only with reference to FIGS. 1 to 6 of the accompanying drawings in which:

FIG. 1 is a plan view of a three electrode sensor element in accordance with the invention;

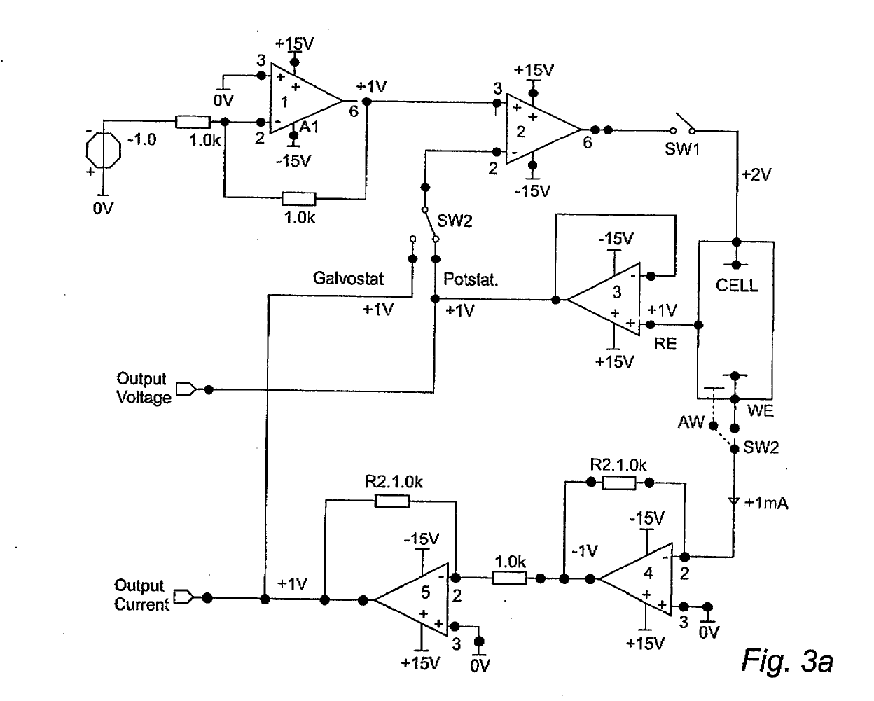

FIG. 2 is a schematic representation of the sensor element of FIG. 1 incorporated into a potentiostatic circuit embodying the principles of the invention; and with reference to the use of the embodiment shown in the figures in analysing an example target species comprising ammonium;

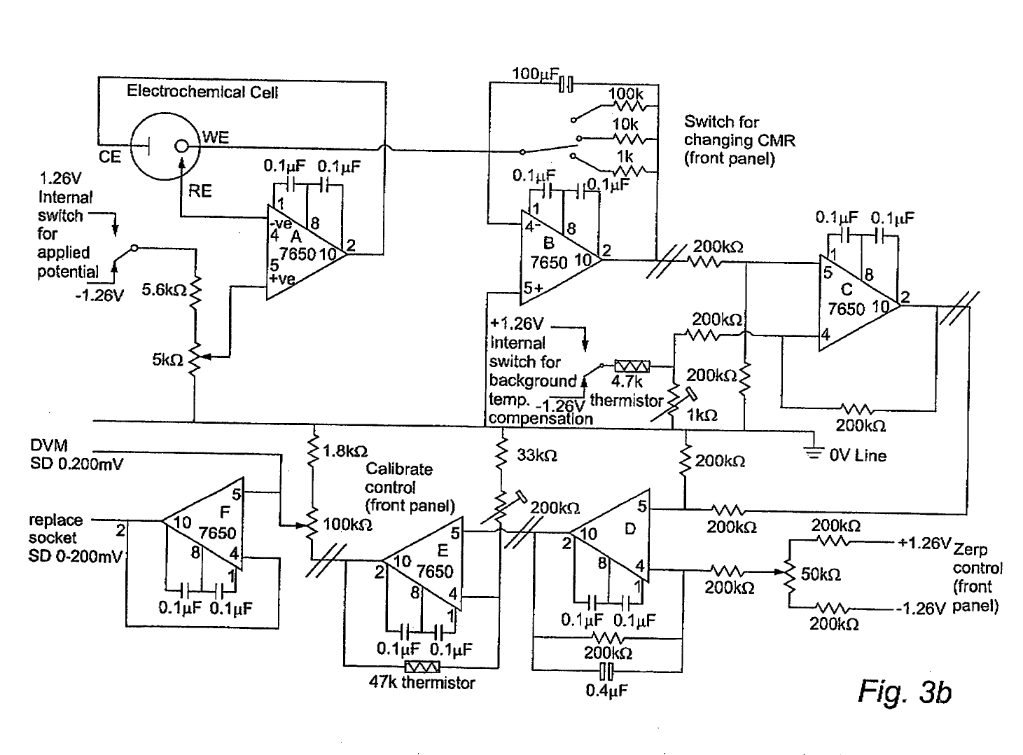

FIG. 3 is example circuitry for FIG. 2, shown in a simple first alternative in FIG. 3a, and in a modified alternative providing for temperature compensation in FIG. 3b;

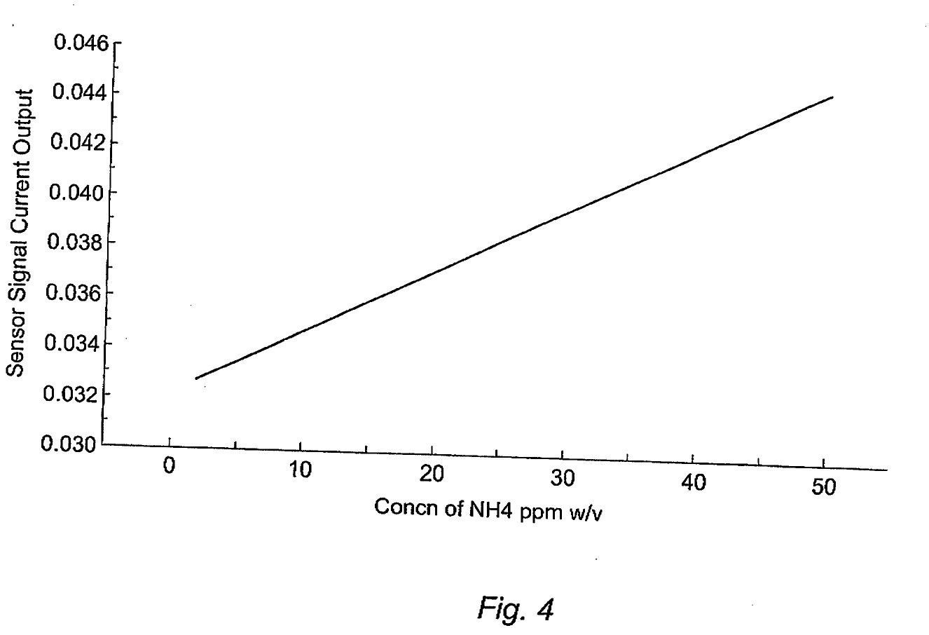

FIG. 4 is a graphical representation of the relationship of current to concentration for an example target species comprising ammonium;

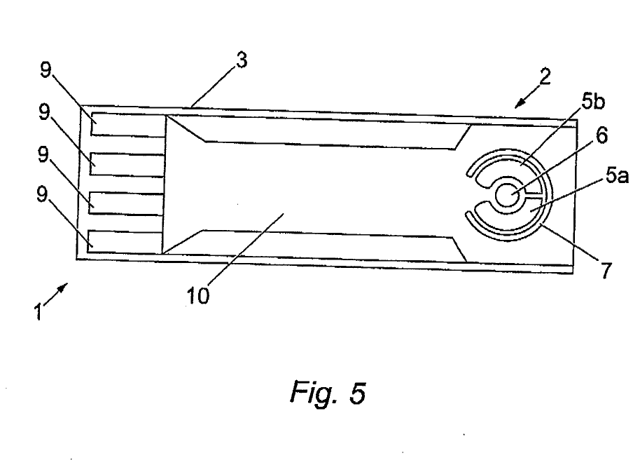

FIG. 5 is a plan view of an alternative four electrode sensor element in accordance with the invention;

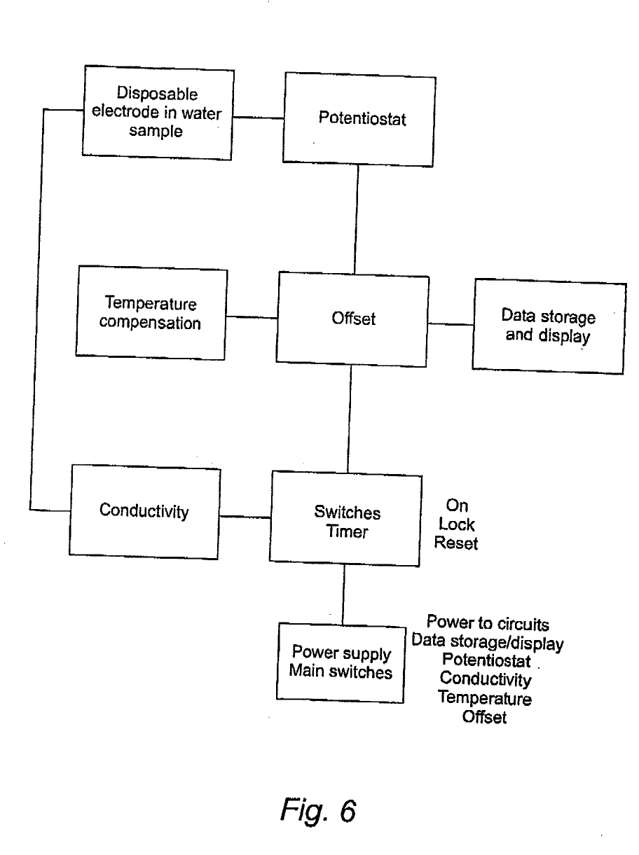

FIG. 6 shows a possible comparator offset circuit arrangement to effect temperature and conductivity conversions.

Referring to FIGS. 1 and 2 a three electrode model is shown suitable for analysing ammonia/ammonium ion. The sensor element (1) comprises noble metallic layers deposited upon an inert, hydrophobic and electrically insulating material, for example a corundum ceramic base (3). Deposited metallic layers comprise a working electrode (5) of silver, a reference electrode (6) of silver, and an auxiliary electrode (7) of silver. Three electrodes (5 to 7) are mutually insulated and connected to the other end of the sensor element by conducting paths (9). The electrodes are exposed in a small sample collection area (2), and the deposited conducting layers otherwise protected by a dielectric protection layer (10).

In use, a disposable electrode (1) is mounted in a housing (11) and a power source (13) drives the reaction. In the example, the measurement process is started by actuation of the button (15). Potentially static conditions can be varied by the control (17). Input data is collected from each electrode via the inputs (18 a-c), converted into machine readable form by the unit (13), and transmitted via the output (19) to a connection (20) for onward analysis by computer.

A simple example of suitable circuitry is illustrated in FIG. 3. FIG. 3a is a basic circuit without provision for temperature compensation. FIG. 3b incorporates two thermistors to correct for E^{O} variation with temperature and for the variation in signal current associated with changes in Temperature.

In use testing for ammonia/ammonium ion a sample is placed on the sample collection area (2). Already present is a reagent comprising a mixture of tri-sodium phosphate and sodium chloride.

The tri-sodium phosphate is a buffer reagent which will adjust the pH of the sample to a value, which is acceptable and necessary for the measurement process to be carried out. Our method relies upon changing the pH of the test solution to about pH 11 to 12. At this alkaline pH value, and with the application of a suitable and specific voltage, free liberated ammonia present in the sample is oxidised. The degree of pH buffering is required to ensure a high degree of conversion of ammonium ion to ammonia irrespective of the original pH of the sample solution source.

The sodium chloride is a reference reagent. An Ag reference electrode is formed as soon as sample liquid (containing NaCl/Na₃PO₄) is present on the surface of the Ag substrate that is being used as the reference electrode. The concentration of NaCl is such that the conditions of the liquid test sample composition are considered. For example 30 gl⁻¹ NaCl would be suitable for pure water, drinking water, river water, seawater, and provides for a constant and the same reference electrode potential for all levels of chlorinity in the sample volume.

The use of standard solution in this manner has advantages in that:
(a) It provides chloride ions for the formation of a reliable reference electrode.
(b) It allows the sensor system to be used for measurement in seawater, potable water, waste waters, drinking waters, etc.
(c) It does not require additional treatments or reagents.
(d) It provides a high pH, which ensures that the sample now contains free ammonia that is released from any ammonium ion present. It is then electrochemically oxidised by use of the potentiostat type circuitry, which furnishes a signal proportional to the concentration of ammonia or ammonium ion in the sample.
(e) No calibration of the system is required before or after use.

The relatively high concentration of chloride ions on Ag in the presence of water will immediately form AgCl on the surface. However in the presence NaCl at a concentration of 30 gl⁻¹ it closely approximates the conventional ‘Standard’ Reference (universally used) Ag, AgCl, 3.5 M KCl or thereabouts. The speed of this formation is very rapid; tens of seconds, especially when compared with a prior art standard solution coated electrode.

Any variation of potential at these high concentrations of chloride ion is negligible, or can easily be corrected to the standard reference potential for comparison purposes. For example for variation of KCl concentration for standard reference by as much as 1M only effects its potential by as little 25 to 50 mV or less. Thus it is largely immaterial whether the initial sample was from seawater, freshwater, brackish sources, biological sources etc.

The suitable mixture of Na₃PO4/NaCl, the standard reagent, may be dissolved directly into the liquid sample. A preferred method however is that during preparation of the electrode the reagent mixture dissolved in water is applied on the surface of the Ag electrode, dried and then sealed for subsequent use. Alternatively, a pre-soaked and dried piece of absorbent material (e.g., capillary matting, and like a stamp hinge) could be stuck to the surface. This item could be packaged similarly with the electrode itself.

In use in the present example a sample is applied to the sample measuring area (9) where the three working electrodes are exposed. The standard reagent effects change of the sample pH to a suitable alkaline pH value, and a specific suitable voltage applied to the working electrode (5) by the unit (13). The free liberated ammonia present in the alkaline sample is oxidised. The oxidation process is carried out electrochemically via the application of the specific and controlled voltage. The applied voltage is carefully selected to carry out the specific and unique process/reaction in the sensor cell, which results ultimately in the generation of electric current. This current is directly proportional to the concentration of the species being measured, and is related to the process being carried out in the sensor cell, as is illustrated for the working example ammonia/ammonium ion system by the plot of current versus concentration in FIG. 4.

The process described above in somewhat general terms can be explained further by a consideration of the principal electrode reactions. It is not suggested that the following reactions are definitive, or that the invention is in any way limited thereby, given the complex chemistry of silver and ammonia. However, as a suggestion for the reaction mechanism with a silver-working electrode the following could be indicated:

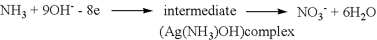

An electrochemical reduction now occurs simultaneously at the counter electrode:

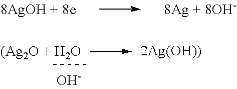

Specificity is not considered a problem or limitation of the method for a number of reasons. The process is one of ‘simply’ oxidising dissolved ammonia electrochemically on silver and at around the oxidation/passivation potentials. Adsorption mechanisms are important in the process. Anions in solution cause no effect in the ammonia oxidation process at the working electrode.

Other background intermediate equations involving potentials, standard electrode potentials E^{O}, etc., for the ammonia oxidation in alkaline solutions are given below. All of these identities of equlibria have almost identical values of E^{O}, which are known to those skilled in the art.
Ag₃PO₄+3e⇄3Ag+PO₄³⁻ a)
Ag(NH₃)₂+e⇄Ag+NH₃ b)
2Ag+2OH⁻⇄2AgOH+2e c)
2Ag+2OH⁻⇄Ag₂O+H₂O+2e d)
Ag₂O+H₂O+2e⇄2Ag+2OH⁻ e)

The sensor can provide measurements of ammonia and ammonium ions over the concentration range 0.5 to 100 ppm w/v. Also, over a temperature range suitable for use in the field, with ambient temperature ranging from 5 to 30° C. at least.

Speed of response for the instrument to achieve 90% of final value is around two minutes.

Minimum limit of detection 0.5 ppm w/v ammonium ion (perhaps less).

The instrument allows measurements of species in saline solution up to, and including seawater strength.

FIG. 5 illustrates an alternative embodiment of sensor element (1). This is generally similar to the sensor element of FIG. 1, and where applicable like reference numerals are used. However it is provided with four electrodes, specifically to deal with a nitrate based chemistry. In particular, two working electrodes (5a, 5b) are provided respectively to drive a reduction and an oxidation reaction. The four electrodes (5a, 5b, 6, 7) are mutually insulated as before and connected to the other end of the sensor element by four conducting paths (9). In some cases the fourth or a fifth electrode could be switched electronically to allow for electrical conductivity measurement corrections as described earlier, or generation of hydrogen as required.

The chemistry is as follows.

It is well known analytically, that nitrate (NO₃⁻) or nitrite (NO₂⁼) ions are easily reduced in alkaline solutions by the hydrogen that can be generated by the addition of metal Zinc.

In the present method however, hydrogen is not necessarily generated by application of a negative potential to the additional electrode (5b) in the sensor electrode assembly. All that may be necessary is the application of a potential of sufficient magnitude (the E^{O} at pH 11 to 12) to automatically reduce the nitrate/nitrite ions to free ammonia. There are at least four electrodes. The illustrated example has four electrodes in total, the working (5a), counter (6) and reference (7) for measurement of the characteristic reaction, and the additional working electrode (5b) for reduction of nitrate/nitrite ion.

Two possible ways can be adopted for the reduction of nitrate or nitrite ion to provide free ammonia. The potential of electrode (5b) could be made sufficiently negative to generate hydrogen. Alternatively, and preferably, hydrogen need not be generated, but by application of a potential around the E^{O} value for the reduction reaction involved for nitrate to ammonium ion (ammonia) i.e., a somewhat more positive value than that which is required to generate free hydrogen.

Moreover, the current derived from the conversion of nitrate/nitrite ion to ammonium ion, not employing hydrogen generation will also be directly related to their original concentration. In addition, by a further step change in potential it is possible to obtain the subsequent ammonia oxidation signal current.

Alternatively, a fourth electrode (5b) is not employed, but by a timer switch mechanism the working electrode is polarised to generate hydrogen for a short time. The potential is then changed to that required for the conversion of nitrite to ammonium ion.

Immediately a signal current is produced, under the control of the potentiostat, due to the oxidation of the NH₃ that has been formed earlier. The signal current is linearly and directly proportional to the concentration of NO₃⁻/NO₂⁼ present in the test sample being measured. A final output signal, on the basis given for the previously mentioned NH₄/NH₃⁺ sensor system, is generated after about two minutes.

From the above it will be realised that the total NO₃⁻/NO₂⁼ concentration of ions is measured in the test sample. Because of the close chemical relationship between NO₃⁻ and NO₂⁼ in practical terms this total quantity is the most important environmentally. However, should a measurement of either one or the other be required, when either or both are present, an alternative test based on an alternative characteristics reaction and/or an alternative form of the 4-electrode system may be employed.

In the present example in the preparation of the electrode assembly the substrate is coated as described earlier for the NH₄/NH₃ type but now with a suitable mixture of containing a reagent to provide for a pH of around 6.8. In this case at the suitable potential for only the NO₃⁼ ion concentration would be obtained. Clearly, two separate disposable electrodes would be used for measurements. Thus, would be made one giving the total and the other only NO₃⁻, simple subtraction could provide a value for NO₂⁼ ion concentration.

Other geometries of electrodes and preparations will be appropriate to other characteristic reactions for other target species.

FIG. 6 shows a possible comparator offset circuit arrangement to effect temperature and conductivity conversions to raw data to accommodate deviation from standard conditions.

The circuit helps to correct the signal produced by the potentiostat before it passes into storage/display etc. The potentiostat current signal from the electrochemical process (oxidation of ammonia in this case) and as generally preferred is converted into a voltage output signal by the usual means. The value is fed into the offset on one of the three channels provided: the other two channel inputs are for the conductivity circuit (when on ‘lock’ status as below) and the temperature compensation circuit, also in voltage modes. A net voltage potentiostat signal due to positive and negative input voltages from the conductivity and temperature compensation is delivered. This resultant signal is then fed into the store/display part of the system.

The conductivity circuit in the example is a conventional and simple high frequency ac type circuit. It is connected to the fourth electrode on the disposable electrode assembly and the counter electrode. A conductivity measurement is made and after three of four seconds the circuit output is electronically ‘locked’ to provide a constant low dc output to one of the three inputs on the offset circuit.

1-29. (canceled)

30. A sensor system for measuring the concentration, or indicating the presence or presence at a predetermined level of, a target contaminant species in an aqueous medium comprising a sensor element having a sample receiving area for receiving a sample of aqueous medium to be sampled and which comprises at least three electrodes each comprising a layer of metallic conductor comprising noble metals of high purity selected from the group consisting of silver, gold, platinum, and palladium in substantially pure form or as alloyed combinations thereof deposited upon an insulating substrate; and further comprising a power source adapted to apply a pre-determined potential difference across two of the electrodes, in use working and counter electrodes, determined by the potential associated with an electrochemical reaction characteristic of the target species, and output means to output data corresponding to the current generated thereby when a sample is in place in the sampling area; and further comprising a pH buffering agent and a reference reagent to be combined with a test solution when it is placed for testing on the sample collection area, the buffering agent being selected to adjust the pH of the sample to a value necessary for the characteristic electrochemical process to be tested and the reference reagent being selected to cause chloride ions to go into solution in the aqueous medium sample to be tested to create a suitable reference solution for the characteristic electrochemical reaction.

31. A sensor system in accordance with claim 30 wherein each electrode comprises a layer of metallic silver in substantially pure form, the reference reagent comprises sodium chloride, and the reference electrode thereby created in situ on the device in use comprises an Ag/AgCl (chloride) reference electrode.

32. A sensor system in accordance with claim 31 wherein the buffering agent is selected to vary the pH of the initial solution to free into solution a species related to and indicative of the contaminant species under test, the characteristic electrochemical process to be tested by the sensor being one involving this related species.

33. A sensor system in accordance with claim 30 adapted for an ammonium/ammonia ion target species wherein the reference reagent comprises sodium chloride and the buffering agent is selected to be such as in use to change the pH of the test solution in excess of 11.

34. A sensor system in accordance with claim 33 wherein the buffering agent comprises Na₃PO₄.

35. A sensor system in accordance with claim 30 adapted for nitrate/nitrite ion target species wherein the reference reagent comprises sodium chloride and the buffering agent is selected to be such as in use to change the pH of the test solution to about 6.8.

36. A sensor system in accordance with claim 30 wherein the sensor electrode element is provided with a layer of a suitable chemical species deposited on the upper surface in the sample collection area such as to be rapidly and very soluble in the aqueous sample and placed thereon to effect formation of the said reference solution and/or buffering solution.

37. A sensor system in accordance with claim 36 wherein the suitable chemical species is deposited directly on the electrode area to form a dry layer thereon.

38. A sensor system in accordance with claim 36 wherein the system further comprises a matting layer applicable to the electrode surface during use and pre-impreganted with the suitable referencing and pH changing chemical species.

39. A sensor system in accordance with claim 30 wherein a power source is integrated into a circuit with the sensor such that the sensor is caused to function as a potentiostat.

40. A sensor system in accordance with claim 39 wherein the power source comprises control means such as to act in combination with the sensor to create a differential pulsed square wave voltammetric circuit.

41. A sensor system in accordance claim 30 wherein the power source is a portable electrical power source for use in the field.

42. A sensor system in accordance with claim 30 further comprising display means to display the output data in a user readable form.

43. A sensor system in accordance with claim 30 wherein the insulating support substrate has hydrophobic surface properties to assist in the retention of a static sample in the sample collection area.

44. A sensor system in accordance with claim 30 wherein the at least three electrodes are deposited on a single supporting substrate.

45. A sensor system in accordance with claim 30 wherein at least some of the at least three electrodes are provided concentrically in the sample area.

46. A sensor system in accordance with claim 45 wherein three electrodes are provided and the electrodes comprise a first electrode making up a central generally circular portion, and second and third electrodes concentrically annular or partially annular there around.

47. A sensor system in accordance with claim 45 wherein four electrodes are provided and the electrodes comprise a first electrode making up a central generally circular portion, and second and third annular electrode portions concentrically annular or partially annular there around, wherein, one or other of the outer annular electrode areas is divided into two mutually insulating portions, to comprise two of the four electrodes.

48. A sensor system in accordance with claim 30 wherein the sensor includes temperature measuring means and/or means to input a measured temperature at the time of sampling, and further comprises means to make a temperature compensation to raw output data based upon this temperature measurement relative to standard conditions.

49. A sensor system in accordance with claim 30 wherein the sensor includes conductivity measuring means to measure solution conductivity, and further comprises means to make a compensation to raw output based upon this measurement relative to standard conditions if necessary.

50. A method of measuring the concentraution, or indicating the presence or presence at a predetermined level of a target contaminant species in an aqueous medium comprising the steps of:
applying a sample of aqueous medium to be tested on a sample collection area of a sensor element comprising at least three electrodes each comprising a layer of metallic conductor comprising noble metals of high purity selected from the group consisting of silver, gold, platinum, and palladium in substantially pure form or as alloyed combinations thereof deposited upon an insulating substrate;
combining the test solution with a pH buffering agent and a reference reagent, the buffering agent being selected to adjust the pH of the sample to a value acceptable and necessary for an electrochemical process to be tested characteristic of the target species and the reference reagent being selected to cause chloride ions to go into solution in the aqueous medium to be tested to create a suitable reference solution for the characteristic electrochemical process;
connecting the electrode to a power source to set up a control circuit;
applying a pre-determined potential difference determined by the potential associated with the electrochemical reaction characteristic of the target species;
awaiting the establishment of a quasi steady state;
outputting data associated with the current of said quasi steady state.

51. A method in accordance with claim 50 wherein each electrode comprises a layer of metallic silver in substantially pure form, the reference solution comprises sodium chloride, and the reference electrode thereby set up in situ on the device in use comprises a Ag/AgCl (chloride) reference with sodium chloride.

52. A method in accordance with claim 50 wherein sodium chloride is added to a solution concentration of about 30 gl⁻¹.

53. A method in accordance with claim 50 for an ammonium/ammonia ion target species wherein the method comprises adding a sodium chloride reference reagent and a buffering agent to change the pH of the test solution to in excess of 11.

54. A method in accordance with claim 53 wherein the buffering agent comprises Na₃PO₄.

55. A method in accordance with claim 50 for nitrate/nitrite ion target species wherein the method comprises adding a sodium chloride reference reagent and a buffering agent to change the pH of the test solution to about 6.8.

56. A method in accordance with claim 50 comprising the further steps of converting the said output current data into data indicative of the presence or presence at a pre-determined level and/or level of concentration of the target species in the sample;
and/or displaying the output data or converted data on suitable user readable display means;
and/or transmitting the output data or converted data to suitable data storage and/or processing means.

57. A method in accordance with claim 50 wherein the said reference/buffer reference solution is created by addition of a suitable reference reagent and buffering agent to the collected sample.

58. A method in accordance with claim 50 wherein the sample collection area of the sensor element is first pre-prepared by provision of suitable chemical species deposited thereon in solid form and able to go into solution when the aqueous sample is applied thereto to effect formation of the reference solution and buffer solution in situ.
